(19) United States
(12) Patent Application Publication
(10) Pub. No.: US 2025/0026689 A1
(43) Pub. Date: Jan. 23, 2025

(54) CORE FOR PRODUCING A CERAMIC MATRIX COMPOSITE DISTRIBUTOR

(71) Applicant: SAFRAN CERAMICS, LE HAILLAN (FR)

(72) Inventors: Simon ARNAL, MOISSY-CRAMAYEL (FR); Gaël Philippe François BATTISTONI, MOISSY-CRAMAYEL (FR); Benjamin COSSOU, MOISSY-CRAMAYEL (FR); Rémy Pierre Marie DUPONT, MOISSY-CRAMAYEL (FR); Gilles Gérard Claude LEPRETRE, MOISSY-CRAMAYEL (FR)

(21) Appl. No.: 18/713,503

(22) PCT Filed: Nov. 25, 2022
(86) PCT No.: PCT/FR2022/052181

§ 371 Date: May 24, 2024

(30) Foreign Application Priority Data
Nov. 26, 2021 (FR) FR2112596

(51) Int. Cl. C04B 35/628; C04B 35/80; C04B 38/00

(52) U.S. Cl. CPC C04B 35/62884; C04B 35/62868; C04B 35/62873; C04B 35/62894; C04B 35/80; C04B 38/0003; C04B 2235/3826; C04B 2235/6028; C04B 2235/614

(57) ABSTRACT

A core for producing a blade is formed by molding a fibrous preform around the core. The core extends in a longitudinal direction (L) between a root and a tip and has a first face and a second face connected to each other at a first longitudinal edge and at a second longitudinal edge. The core includes fluid passages formed in a transverse thickness of the core, these fluid passages being adapted to allow the passage of fluid from the first face to the second face and vice versa.

### TECHNICAL FIELD OF THE INVENTION

This document concerns distributors (the upstream guide vanes of a turbine stage) made of a ceramic matrix composite, and more particularly concerns cores for obtaining such distributors.

### PRIOR ART

This document falls within the field of distributors made of a ceramic matrix composite (CMC). Patent application WO2019068987A1 describes the steps of a method for obtaining CMC parts. The main steps of such a method are recalled below.

As illustrated in FIG. 1, the method for producing distributors comprises a first step of positioning a fibrous preform around a core 2 made of oxidizable material, the core ensuring a three-dimensional configuration of a cavity inside of the fibrous preform. Core 2 is made of carbon, graphite, or another carbon-derived material. The fibrous preform is obtained by weaving warp threads and weft threads in a manner well known to those skilled in the art.

The fibrous preform, and the core 2 inserted into a hollow area of the fibrous preform, are then placed in a shaping device in order to produce a three-dimensional configuration of the fibrous preform, corresponding to the final shape of the distributor.

The fibrous preform is densified during a step of chemical vapor deposition of boron nitride (BN). This step is called “Chemical Vapor Infiltration” (CVI), and several cycles are carried out. The gas phase includes precursors such as boron trichloride BCl₃ and ammonia NH₃. Boron nitride is used because it is resistant to oxidation and has good mechanical properties. Boron nitride acts as a mechanical “fuse” and has a strong resistance to high temperatures (1400° C.). This CVI step is very important, because it allows fixing the dimensions of the CMC part that is to be manufactured. This step will allow giving the part its mechanical properties: the quality of the deposition during the different CVI cycles controls the mechanical resistance of the final part. In the shaper, a deposition of silicon carbide SiC is carried out using the gases CH₃SiCl₃ and H₂. This silicon carbide SiC deposit is configured to protect the boron nitride BN from the air. The part is taken out of the shaper and is exposed to air.

Thirdly, core 2 is removed from the part in order to obtain a fibrous preform having a hollow area. Then a second deposition of silicon carbide SiC is carried out using the gas CH₃SiCl₃. This second deposition of silicon carbide protects the part from the subsequently injected liquid silicon. The part is infiltrated with silicon carbide powder via a slurry capable of filling the high porosities. Finally, the distributor thus obtained receives an infiltration of liquid silicon metal in order to finish filling the porosities of the material. This densification step is carried out at a temperature between 1400° C. and 1450° C.

In this method, the core provides structure and resists the CVI cycles which involve high temperatures and a harsh atmosphere.

During the CVI cycles, the gases will circulate in the part in order to be deposited on the fibrous preform. However, as illustrated in FIG. 1, the conventional cores 2 employed have a solid structure: they are solid with a continuous surface and completely fill the cavity. This configuration blocks the passage of gases, which do not travel through the core from one side to the other. This has the effect of disrupting the deposition of BN, in particular by limiting the deposition in areas that are difficult to access.

As a result of this configuration, on all faces in contact with the core, a diffusion gradient is formed from each suction-side (“extrados”) face of the blade preform towards the core, in a direction substantially transverse to the suction-side face of the blade preform. A similar gradient is observed from the pressure-side (“intrados”) face. The closer one is to core 2, the more the thickness of the BN layer deposited is reduced, such that a thickness may be obtained that is below what is required in the manufacturing specifications. If the BN thickness is less than the specifications, when the part is subjected to mechanical stress the BN thickness will not be sufficient to transfer the mechanical load to the fibers. As a result, the part will have insufficient mechanical properties that will not have the correct specifications.

This also impacts the subsequent steps of the method. Thus, during the step of infiltration with silicon carbide powder via the slurry, the slurry thickness is insufficient. As a result, liquid silicon diffuses through the SiC layer and attacks the BN. The part then loses these mechanical properties.

The present invention aims to remedy these disadvantages, in a simple, reliable, and inexpensive manner.

### SUMMARY OF THE INVENTION

The present invention relates to a core for manufacturing a blade by molding a fibrous preform around said core, the core extending in a longitudinal direction (L) between a root and a tip and comprising a first face and a second face connected to each other at a first longitudinal edge and at a second longitudinal edge, characterized in that it comprises fluid passages formed within a transverse thickness of the core, these fluid passages being adapted to allow a passage of fluid from the first face to the second face and vice versa.

One will understand that the core comprises fluid passages which have mouths at the first face and at the second face.

The fluid passages at the core make it possible to increase the circulation of gases within the cavity, and ultimately to obtain a homogeneous deposition of BN and SiC on the distributor.

This therefore makes it possible to eliminate the gradient which was present when the core was solid as in the prior art. Such a core allows improving the mechanical performance of the ceramic matrix composite part. Under such conditions, there is then a suitable amount of interphase to allow obtaining sufficient breaking stress. In addition, this prevents areas of mechanical weakness, causing a drop in modulus. These positive factors are present due to a suitable thickness of BN: neither too low nor too high.

By means of these measures, it is possible to obtain a suitable SiC thickness, i.e. neither too high nor too low. Thus, SiC can fulfill its role as a barrier to liquid silicon during the densification step, avoiding silicon attack on the BN and degradation of the mechanical performance of the ceramic matrix composite part. In addition, due to the suitable thickness of the SiC that is obtained, the part is properly filled in during the densification step in particular, which allows improving the thermal performance of the ceramic matrix composite part. Good resistance to oxidation and to creep at high temperatures is thus obtained.

Said fluid passages in the core may comprise substantially rectilinear orifices.

Mouths of the core orifices may form a square unit pattern arrangement.

The total surface area of the mouths of the fluid passages at each among the first face and the second face may correspond to at least 5% of the surface area of the face concerned.

At least one among the first face and the second face may comprise connecting channels between at least some of the mouths of the fluid passages.

The fluid passages may have a polygonal shape, for example hexagonal.

The core may comprise a foam structure, said fluid passages being formed by open cells of said foam.

The first face of the core forms a concave curve, and the second face forms a convex curve.

Thus shaped, these faces are intended to be shaped in a manner similar to the pressure-side face and suction-side face of the fibrous preform.

This document also relates to an assembly comprising a core as described above and a fibrous preform comprising a housing in which the core is arranged, the preform comprising a pressure-side wall comprising an external face or suction-side face and an internal face arranged opposite the suction-side face and facing the first face of the core, and a suction-side wall comprising a suction-side face or external face and an internal face arranged opposite the pressure-side face and facing the second face of the core, mouths of the fluid passages being oriented towards the pressure-side face and towards the suction-side face.

Thus, the mouths of the fluid passages at the first face are oriented towards the pressure-side wall and therefore towards the internal pressure-side face, and the mouths of the fluid passages at the second face are oriented towards the suction-side wall and therefore towards the internal suction-side face. The circulation of gases thus takes place optimally through the pressure-side walls and the suction-side walls from or towards the pressure-side or suction-side faces of the fibrous preform. In other words, the exit direction of each mouth of an orifice intercepts one or the other of the internal faces or the fibrous preform. Similarly, the exit direction of each mouth of an orifice intercepts one or the other of the pressure-side or suction-side faces of the fibrous preform. The circulation of gases is thus optimal through the core and through the fibrous preform.

The assembly may comprise a shaper surrounding the fibrous preform so as to create a predetermined three-dimensional configuration for the fibrous preform.

The shaper may comprise walls in contact with the fibrous preform, these walls comprising fluid passages connected to means for supplying the interior of the shaper with fluid.

The fluid passages at the shaper also allow improving the circulation of gases around the shaper and towards the fibrous preform.

The mouths of the fluid passages in the walls of the shaper may be connected by connecting channels.

This document concerns a method for manufacturing a blade, comprising:
providing an assembly as described above,
carrying out a first densification of the fibrous preform with a first cycle of chemical vapor infiltration comprising a deposition of BN and a first layer of SiC;
carrying out the deposition of a slurry comprising a silicon carbide powder, on the fibrous preform;
carrying out a densification of the blade obtained, using liquid silicon metal.

In the CVI cycles, the gases circulate through the fibrous preform and through the fluid passages of the core, which avoids any formation of a diffusion gradient in the pressure-side and suction-side walls of the fibrous preform, i.e. the walls comprising the pressure-side face and the wall comprising the suction-side face.

This method of manufacturing by using a core as described above makes it possible to improve the mechanical performance of the blade obtained and in particular a sufficient breaking stress, by allowing an unobstructed circulation of gases. In addition, this prevents areas of mechanical weakness within the blade, causing a drop in modulus. These positive factors are present due to the suitable thickness of the BN, neither too low nor too high, due to the fluid passages in the core.

By means of this method, it is also possible to obtain a suitable SiC thickness. Thus, SiC can fulfill its role as a barrier to liquid silicon during the densification step, avoiding silicon attacks on the BN and degradation of the mechanical performance of the ceramic matrix composite part. In addition, due to the suitable thickness of SiC that is obtained, the part is properly filled in during the densification step in particular, which allows improving the thermal performance of the ceramic matrix composite part. Good resistance of the blade to oxidation and creep at high temperatures is thus obtained.

Furthermore, due to the core that is employed in the method, all steps of the method take place correctly. Thus, during the step of infiltration with silicon carbide powder via the slurry, the slurry thickness is sufficient, unlike in the prior art with its solid core. As a result, the liquid silicon does not diffuse through the SiC layer and does not attack the BN. The part therefore retains its mechanical properties.

### BRIEF DESCRIPTION OF THE FIGURES

The invention will be better understood and other features and advantages will become apparent upon reading the detailed description which follows, given on a non-limiting basis with reference to the figures in which:

FIG. 1, already described above, is a core according to the prior art;

FIG. 2 illustrates a core according to a first embodiment; this figure comprises a portion A showing a first face of the core and a portion B showing a second opposite face of the core;

FIG. 3 illustrates a core according to a second embodiment; this figure comprises a portion A showing a first face of the core and a portion B showing a second opposite face of the core;

FIG. 4 illustrates a section view of a core surrounded by a fibrous preform and a core;

FIG. 5 illustrates a core and an associated shaper, according to the invention.

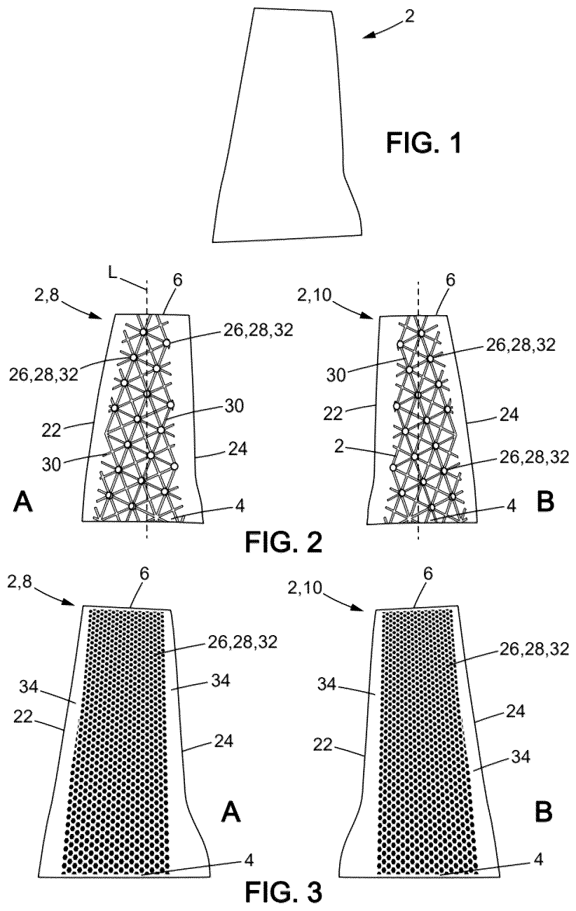

### DETAILED DESCRIPTION OF THE INVENTION

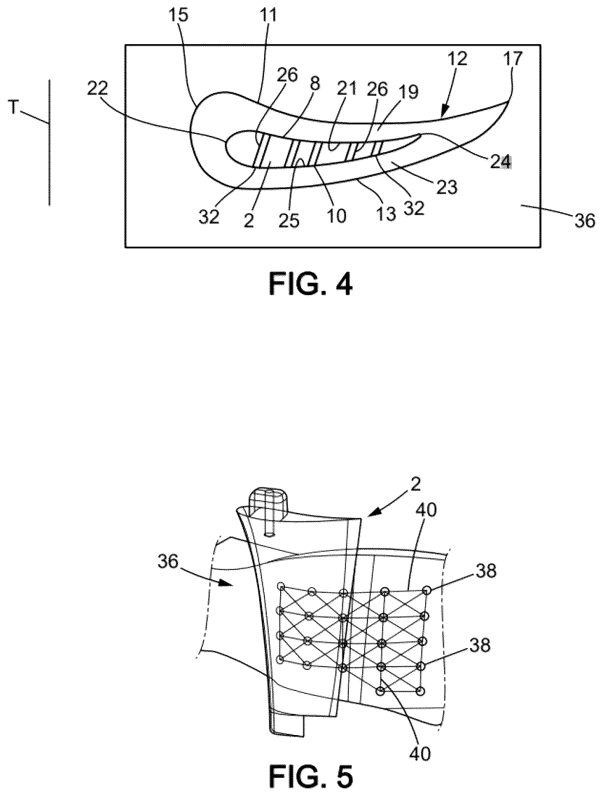

As illustrated in FIG. 2, this document concerns a core 2 extending in a longitudinal direction L between a root 4 and a tip 6. It comprises a first face 8 and a second face 10 which are opposite one another in a direction T that is transverse to the longitudinal direction L and passes through the pressure-side and suction-side faces of a fibrous preform 12 as shown in FIG. 4.

As illustrated in FIG. 4, core 2 is arranged inside a fibrous preform 12. More precisely, core 2 is arranged within an internal housing of fibrous preform 12, or else fibrous preform 12 surrounds core 2 so as to define a housing in which the preform is housed and entirely contained. Fibrous preform 12 comprises a pressure-side face 11 and a suction-side face 13 connected to each other by a leading edge 15 and a trailing edge 17. Pressure-side face 11 is formed on the exterior of a pressure-side wall 19 of which an internal face 21 is applied against first face 8 of core 2. Suction-side face 13 is formed on the exterior of a suction-side wall 23 of which an internal face 25 is applied against second face 10 of core 2. First face 8 of core 2 has a concave shape and second face 10 of core 2 has a convex shape. Pressure-side wall 19 comprises a pressure-side face 11 or external face and an internal face 21 opposite pressure-side face 11 and facing first face 8 of core 2. Suction-side wall 23 comprises a suction-side face 13 or external face and an internal face 25 opposite suction-side face 13 and facing second face 10 of core 2.

As illustrated in FIG. 4, first face 8 of core 2 is a face intended to come into contact with fibrous preform 12, first face 8 being applied against internal face 21 of pressure-side wall 19 of preform 12. Second face 10 of core 2 is a face intended to come into contact with fibrous preform 12, second face 10 being applied against internal face 25 of suction-side wall 23 of preform 12. First face 8 and second face 10 of core 2 are connected to each other at a first longitudinal edge 22 and at a second longitudinal edge 24.

Core 2 comprises fluid passages 26 in a transverse thickness of core 2. Fluid passages 26 are adapted to allow a passage of fluid from first face 8 of core 2 to second face 10 of core 2 and vice versa. Fluid passages 26 comprise substantially rectilinear orifices 28. Orifices 28 have a diameter of between 1 and 6 mm, preferably 5 mm. The total surface area of the mouths of fluid passages 26 at each among first face 8 and second face 10 of core 2 represents at least 5% of the surface area of said face concerned.

A core 2 may further comprise connecting channels 30 which join the mouths of fluid passages 26. These connecting channels 30 are present on the surface on first face 8 and second face 10 of core 2. Connecting channels 30 thus connect fluid passages 26. Mouths 32 of orifices 28 form a square unit pattern arrangement. Diagonals of this square pattern and edges of this square are created by connecting channels 30. Each fluid passage 26 thus comprises eight outgoing connecting channels 30. The part is homogeneous to the extent that the number of fluid passages 26 and connecting channels 30 are quantitatively identical regardless of the height of the part. The surface area occupied by fluid passages 26 is calculated so as to be as large as possible, the limit being the mechanical strength of the material used.

Core 2 comprises a passage-free strip 34 at first longitudinal edge 22 and at second longitudinal edge 24. Passage-free strip 34 does not comprise any fluid passages 26 nor any connecting channels 30, follows the geometry of the core, and is wider at the bottom. The thickness of first longitudinal edge 22 and second longitudinal edge 24 varies while being thicker towards root 4 of the core.

According to one particular embodiment, core 2 comprises fluid passages 26 having a polygonal shape, preferably hexagonal. Each fluid passage 26 is delimited by a border. This cell border defines the spacing between each fluid passage.

According to another particular embodiment, core 2 comprises a foam structure comprising open cells as fluid passages 26. These cells comprise pores which are in communication with each other from one face to another.

As illustrated in FIGS. 4 and 5, core 2 is housed in a fibrous preform 12 surrounded by a shaper 36. A shaper 36 is a mold which allows keeping fibrous preform 12 in the shape that one wishes to give it. Shaper 36 is then positioned in a reactor which allows conducting CVI cycles in order to deposit the BN. Shaper 36 comprises fluid passages 38 in its walls in contact with fibrous preform 12. Fluid passages 38 of the shaper are connected to means for supplying the interior of shaper 36 with fluid. The shaper comprises connecting channels 40 in the walls and between fluid passages 38, through which the gases circulate in order to supply the external faces of fibrous preform 12. Fluid passages 38 of the shaper have a diameter of between 1 and 6 mm, preferably 5 mm. There is thus a synergy between shaper 36 and the core 2 employed.

Fluid passages 26 and connecting channels 30 at core 2 make it possible to increase the circulation of gases within the cavity and to obtain a homogeneous deposition of BN and of SiC slurry on the fibrous preform of the distributor.

This therefore makes it possible to eliminate the gradient present on a solid core of the prior art. Such a core 2 allows improving the mechanical performance of the ceramic matrix composite part. Under such conditions, there is then a suitable amount of interphase to allow obtaining sufficient breaking stress. In addition, this prevents areas of mechanical weakness causing a drop in modulus. These positive factors are present due to a suitable thickness of BN: neither too low nor too high.

By means of these measures, it is possible to obtain a suitable SiC thickness, i.e. neither too high nor too low. SiC can thus fulfill its role as a barrier to liquid silicon during the densification step, avoiding silicon attack on the BN and degradation of the mechanical performance of the ceramic matrix composite part. In addition, due to the suitable thickness of SiC that is obtained, the part is properly filled in during the densification step in particular, which allows improving the thermal performance of the ceramic matrix composite part. Good resistance to oxidation and creep at high temperatures is thus obtained.

The homogeneity in the positioning of fluid passages 26 and connecting channels 30 of the core over the entire height of the part makes it possible to avoid inhomogeneities in the part. Furthermore, in such a configuration, a contact surface between the part and the core is sufficient for the mechanical function of the part to be fulfilled.

Towards the leading edge and trailing edge on the core, the passage-free strips help protect these fragile areas.

The fluid passages 38 and connecting channels 40 of the shaper also allow improving the circulation of gases around the shaper and towards the fibrous preform.

This document further relates to a method for manufacturing a blade, comprising:
providing a fibrous preform around a core as described above;
positioning the fibrous preform and the core in a shaper;
carrying out a first densification of the fibrous preform with a first CVI cycle comprising a deposition of BN and a first layer of SiC;
removing the core;
carrying out a second densification of the fibrous preform with a second CVI cycle comprising a second layer of SiC;
carrying out the deposition of a slurry comprising a silicon carbide powder, on the fibrous preform;
carrying out a densification of the blade obtained, using a liquid silicon metal.

The core may be removed either mechanically, for example by disintegration using a jet of water, or chemically.

1. A core (2) for manufacturing a blade by molding a fibrous preform (12) around said core (2), the core (2) extending in a longitudinal direction (L) between a root (4) and a tip (6) and comprising:
a first face (8); and
a second face (10) connected to each other at a first longitudinal edge (22) and at a second longitudinal edge (24);
wherein the fluid passages (26) being adapted to allow a passage of fluid from the first face (8) to the second face (10) and vice versa.

2. The core according to claim 1, wherein said fluid passages (26) of the core comprise substantially rectilinear orifices (32).

3. The core according to claim 1, wherein mouths of the orifices (32) of the core (2) form a square unit pattern arrangement.

4. The core according to claim 1, wherein the total surface area of the mouths of the fluid passages (26) at each among the first face (8) and the second face (10) of the core (2) comprises at least 5% of the surface area of said face concerned.

5. The core according to claim 4, wherein at least one among the first face (8) and the second face (10) comprises connecting channels between at least some of the mouths of the fluid passages (26).

6. The core according to claim 1, wherein the fluid passages (26) have a polygonal shape, for example hexagonal.

7. The core according to claim 1, wherein the core (2) comprises a foam structure, said fluid passages (26) being formed by open cells of said foam.

8. The core according to claim 1, wherein the first face (8) of the core forms a concave curve and the second face (10) forms a convex curve.

9. An assembly comprising a core according to claim 1 and a fibrous preform (12) comprising a housing in which the core is arranged, the fibrous preform (12) comprising:
a pressure-side wall (19) comprising a pressure-side face (11) and an internal face (21) arranged facing the first face (8) of the core (2); and
a suction-side wall (23) comprising a suction-side face (13) and an internal face (25) arranged facing the second face (10) of the core (2), mouths of the fluid passages being oriented towards the pressure-side face (11) and towards the suction-side face (13).

10. The assembly according to claim 9, comprising
a shaper (36) surrounding the fibrous preform (12) so as to create a predetermined three-dimensional configuration for the fibrous preform (12).

11. The assembly according to claim 10, wherein the shaper (36) comprises walls in contact with the fibrous preform (12), these walls comprising fluid passages (38) connected to means for supplying the interior of the shaper (36) with fluid.

12. The assembly according to claim 11, wherein the mouths of the fluid passages (38) in the walls of the shaper are connected by connecting channels (40).

13. A method for manufacturing a blade, comprising:
providing an assembly comprising a core according to claim 1 and a fibrous preform (12) having a housing in which the core is arranged;
carrying out a first densification of the fibrous preform with a first cycle of chemical vapor infiltration comprising a deposition of BN and a first layer of SiC;
carrying out a second densification of the fibrous preform with a second cycle of CVI comprising a second layer of SiC;
carrying out the deposition of a slurry comprising a silicon carbide powder, on the fibrous preform;
carrying out a densification of the blade obtained, using liquid silicon metal.

14. The assembly according to claim 9, wherein said fluid passages (26) of the core comprise substantially rectilinear orifices (32).

15. The assembly according to claim 14, wherein mouths of the orifices (32) of the core (2) form a square unit pattern arrangement.

16. The assembly according to claim 15, wherein the total surface area of mouths of the fluid passages (26) at each among the first face (8) and the second face (10) of the core (2) comprises at least 5% of the surface area of said face concerned.

17. The assembly according to claim 16, wherein at least one among the first face (8) and the second face (10) comprises connecting channels between at least some of the mouths of the fluid passages (26).

18. The assembly according to claim 9, wherein the fluid passages (26) have a polygonal shape, for example hexagonal.

19. The assembly according to claim 9, wherein the core (2) comprises a foam structure, said fluid passages (26) being formed by open cells of said foam.

20. The assembly according to claim 9, wherein the first face (8) of the core forms a concave curve and the second face (10) forms a convex curve.
